(19) United States
(12) Patent Application Publication
(10) Pub. No.: US 2015/0063149 A1
(43) Pub. Date: Mar. 5, 2015

(54) METHOD FOR AUTOMATICALLY MEASURING PROPAGATION CHARACTERISTICS OF MILLIMETER RADIO WAVES AND ACQUIRING DATA USING SIMPLE NETWORK MANAGEMENT PROTOCOL IN REAL TIME

(71) Applicant: ELECTRONICS AND TELECOMMUNICATIONS RESEARCH INSTITUTE, Daejeon (KR)

(72) Inventors: Jong Ho KIM, Daejeon (KR); Myoung Won JUNG, Chungcheongnam-do (KR)

(21) Appl. No.: 14/475,810

(22) Filed: Sep. 3, 2014

(30) Foreign Application Priority Data
Sep. 4, 2013 (KR) 10-2013-0105969

(51) Int. Cl. H04W 24/08; H04L 12/24

(52) U.S. Cl. CPC H04W 24/08; H04L 41/0213
USPC 370/252

(57) ABSTRACT

Provided is a method for automatically measuring propagation characteristics of millimeter radio waves and acquiring data using a simple network management protocol (SNMP) in real time. A remote server may control a transmitter control terminal and a receiver control terminal, which control a transmitter and receiver separated from each other at a predetermined distance so as to measure propagation characteristics, through a wired/wireless network using the SNMP.

### CROSS-REFERENCE TO RELATED APPLICATIONS

The present application claims priority of Korean Patent Application No. 10-2013-0105969, filed on Sep. 4, 2013, which is incorporated herein by reference in its entirety.

### BACKGROUND OF THE INVENTION

1. Field of the Invention

Exemplary embodiments of the present invention relate to a method for automatically measuring propagation characteristics of millimeter radio waves and acquiring data in real time; and, more particularly, to a method for automatically measuring propagation characteristics of millimeter radio waves and acquiring data using a simple network management protocol (SNMP) in real time, which remotely controls a system and acquires data through network control based on SNMP, stores and analyzes the acquired data, and performs a statistics process on the data.

2. Description of Related Art

A conventional communication system operating in 70/80 GHz bands directly connects a measurement device to a storage device through a line, and stores and control data, in order to transmit data at 10 Gbps. That is because the conventional communication system analyzes an accumulated result of measurement data, determines communication availability, and derives a result. However, due to the recent sudden change of the precipitation environment, a communication system operating in a millimeter radio-wave band of 70/80 GHz or more needs to control and analyze a real-time measurement system because the attenuation characteristic is frequently changed even in a light-of-sight (LOS) environment due to atmospheric attenuation caused by the atmosphere, rain attenuation caused by rain, or attenuation caused by fog or snowfall. Furthermore, even when the accumulated measurement data cannot be obtained due to a strong wind caused by a typhoon or the like, a measurement result for data obtained until the measurement is completed may be secured in case where real-time measurement data are secured. Thus, since the worst case can be suggested in propagation characteristic analysis, the result may have a significant meaning.

Furthermore, in a conventional propagation environment measurement method in a millimeter radio-wave band, real-time monitoring, a DAQ (Data Acquisition) function, and automation control cannot be remotely performed in a propagation measurement result acquisition method using RS 232 and DAQ boards.

Conventionally, when an attenuation characteristic caused by rainfall, dry atmosphere, fog, or humidity in the millimeter radio-wave band is measured and analyzed to derive a propagation characteristic, propagation characteristics at a single frequency are measured, the measurement data are accumulated and stored, and the stored data are used to analyze the measurement result, thereby deriving statistical characteristics for attenuation characteristics based on the atmospheric environment at the measurement region.

Such a conventional method performs data analysis and corrects a measurement system error using the accumulated data. Thus, the conventional method cannot analyze the measurement result and support the system, through real-time measurement data. Furthermore, the conventional method may recognize a result caused by an abnormal operation of the measurement system while analyzing the measurement result, and then take a measure against the result. However, the conventional method cannot correct an operation error through real-time measurement system monitoring, and cannot perform error data removal and result derivation which may be performed through real-time analysis for measurement data.

### SUMMARY OF THE INVENTION

An embodiment of the present invention is directed to a method for automatically measuring propagation characteristics of millimeter radio waves and acquiring data using a simple network management protocol (SNMP) in real time, which is capable of controlling a measurement system and acquiring measurement data in a millimeter radio-wave band of 70/80 GHz or more through a remote connection method in real time.

Another embodiment of the present invention is directed to a method for automatically measuring propagation characteristics of millimeter radio waves and acquiring data using a simple network management protocol (SNMP) in real time, which is capable of performing a DAQ (Data Acquisition) function, automation control, and real-time statistics analysis through real-time remote automatic control which cannot be realized in conventional propagation characteristic measurement systems, thereby improving efficiency and precision of the propagation characteristic analysis method.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, there is provided a method for automatically measuring propagation characteristics of millimeter radio waves and acquiring data using an SNMP in real time. A remote server may control a transmitter control terminal and a receiver control terminal, which control a transmitter and receiver separated from each other at a predetermined distance so as to measure propagation characteristics, through a wired/wireless network using the SNMP.

The remote server may directly control the transmitter and the receiver through the wired/wireless network using the SNMP.

The remote server may provide a user interface configured to check and control an attenuation measurement result, and a data traffic state, the operation states of the transmitter, the receiver, the transmitter control terminal, and the receiver control terminal, which measures the propagation characteristics, in real time.

### BRIEF DESCRIPTION OF THE DRAWINGS

FIG. 1 is a diagram illustrating the set-up of a system for measuring rain attenuation characteristics in a millimeter radio-wave band in accordance with an embodiment of the present invention.

FIG. 2 is a configuration diagram of an RTRC (Real Time Remote Control) propagation characteristic measurement system using SNMP in accordance with the embodiment of the present invention.

FIG. 3 is an example illustrating a GUI (Graphic User Interface) of the RTRC propagation characteristic measurement system using the SNMP of FIG. 2.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

A method for automatically measuring propagation characteristics of millimeter radio waves and acquiring data using a simple network management protocol (SNMP) in real time in accordance with an embodiment of the present invention may analyze a measurement result and support the system using a real-time measurement result, unlike the conventional method which analyzes data and corrects a measurement system error using accumulated data.

Furthermore, the method for automatically measuring propagation characteristics of millimeter radio waves and acquiring data using SNMP in real time in accordance with the embodiment of the present invention may correct an operation error through real-time measurement system monitoring, and analyze measurement data in real time. Thus, since error data removal and result derivation may be directly performed, the efficiency of the measurement system may be maximized.

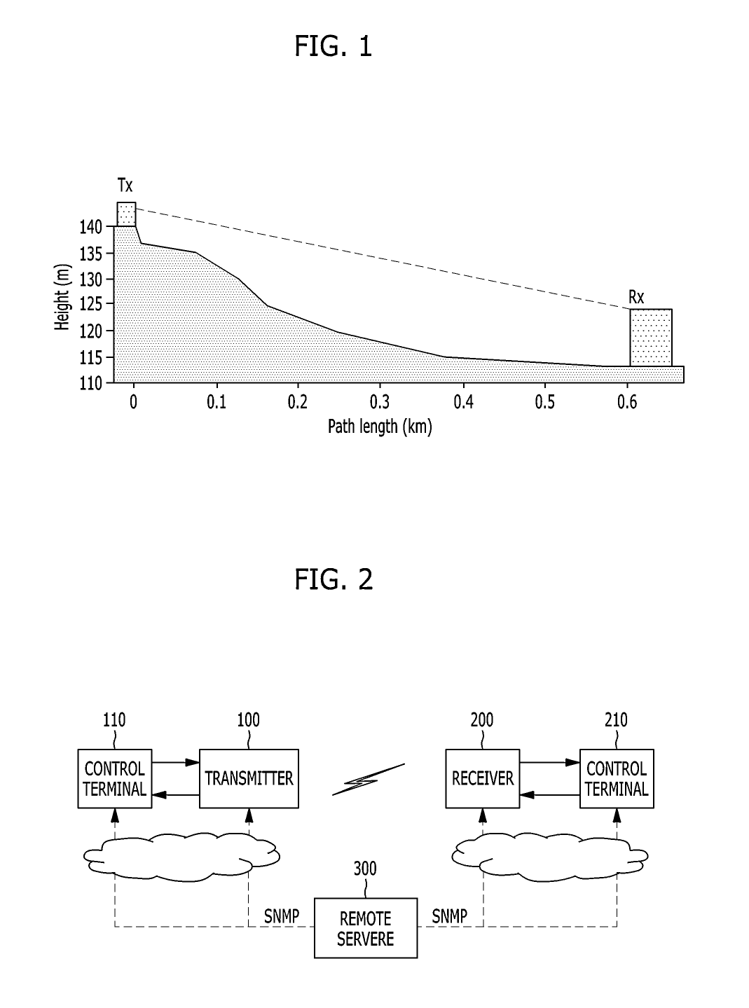

First, the method for automatically measuring propagation characteristics of millimeter radio waves and acquiring data using SNMP in real time in accordance with the embodiment of the present invention will be described in detail with reference to FIG. 1.

FIG. 1 is a diagram illustrating the set-up of a system for measuring rain attenuation characteristics in a millimeter radio-wave band in accordance with the embodiment of the present invention. Referring to FIG. 1, a measurement system for two kinds of single frequencies such as 40 GHz and 60 Ghz may be constructed to measure attenuation characteristics in a rain, fog, humidity, and dry atmospheric state and derive the measurement result. However, all the measurement data are accumulated data. Thus, when the measurement is not normally performed due to high temperature, strong wind, heavy rain or the like which occurs during the measurement, a measure against the abnormality cannot be immediately taken. In this case, the system must rely on the recording state of the measurement data.

Furthermore, a system for measuring propagation characteristics in 80 GHz band is configured in the same manner as the above-described method. Thus, the system cannot perform real-time remote system control and management and data storage.

Thus, the method for automatically measuring propagation characteristics of millimeter radio waves and acquiring data using SNMP in real time in accordance with the embodiment of the present invention may construct a measurement system as illustrated in FIG. 2. The method may remotely manage and control a system and acquire data in real time through network control based on SNMP in a fixed measurement system, thereby storing and analyzing the data and performing error handling and statistics process.

FIG. 2 is a configuration diagram of an RTRC (Real Time Remote Control) propagation characteristic measurement system using SNMP in accordance with the embodiment of the present invention. Referring to FIG. 2, a transmitter 100 and a receiver 200 which are separated at a predetermined distance of 500 m, for example, to measure propagation characteristics are connected to control terminals 110 and 210, respectively, through LAN lines such as CAT.6 UTP cables. The control terminals 110 and 120 are connected to the transmitter 100 and the receiver 200 through the UDP cables and RJ-45 ports based on 10/100/1000base-T standard. The control terminals 110 and 210 may include a laptop computer which can be easily carried.

At this time, a remote server 300 controls the control terminals 110 and 210 to manage the measurement system, through the SNMP. Thus, when the propagation characteristic measurement system is managed, the remote server 300 may transmit a simple message-type control command to the measurement system so as to control the operation. Therefore, the remote server 300 may control the measurement system without applying a load to the network. At this time, the remote server 300 may transmit information of 1 or 2 as an OID address 000012313 or 2399234024, in order to control the system. Furthermore, the remote server 300 may directly control the transmitter 100 and the receiver 200 to control the measurement system, without controlling the control terminals 110 and 210.

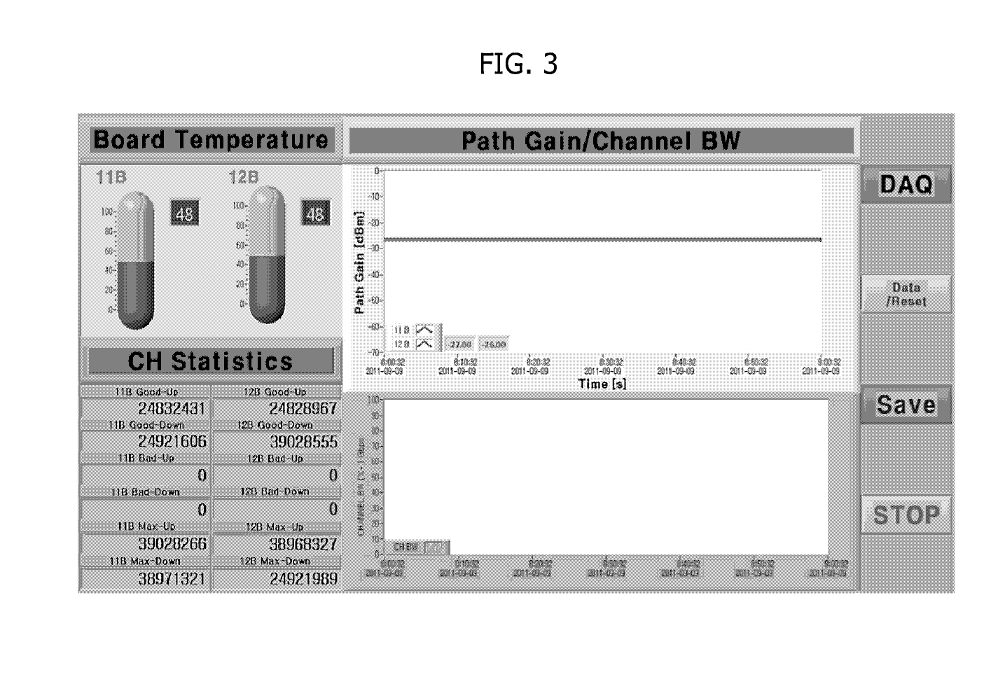

FIG. 3 is an example illustrating a GUI (Graphic User Interface) of the RTRC propagation characteristic measurement system using the SNMP of FIG. 2. The GUI may be configured to check and control the operation state of the measurement system, an attenuation measurement result, a data traffic state at the control terminals 110 and 210 or the remote server 300.

As described above, the method for automatically measuring propagation characteristics of millimeter radio waves and acquiring data using SNMP in real time in accordance with the embodiment of the present invention may remotely manage the system and acquire data through the network control based on the SNMP in the fixed measurement system, thereby storing and analyzing the data and performing error handling and statistics process.

Furthermore, the method for automatically measuring propagation characteristics of millimeter radio waves and acquiring data using SNMP in real time in accordance with the embodiment of the present invention may remotely control the measurement system in real time, remove errors occurring in the measurement process in real time, and derive statistics analysis for the measurement result in real time.

Furthermore, the method for automatically measuring propagation characteristics of millimeter radio waves and acquiring data using SNMP in real time in accordance with the embodiment of the present invention may increase the efficiency of measurement management, data storage, and analysis in the measurement process for estimating millimeter radio wave propagation, and minimize the occurrence of errors.

In accordance with the embodiments of the present invention, when measurement for propagation estimation of a high-frequency band such as a millimeter radio-wave band is performed, the method may remotely manage and control the measurement system in real time, store and monitor measurement data, and minimize troubles occurring in the measurement process.

Furthermore, since the method performs a statistics process for measurement data in real time, the method may not increase the load for data analysis, thereby improving efficiency in propagation characteristic estimation.

While the present invention has been described with respect to the specific embodiments, it will be apparent to those skilled in the art that various changes and modifications may be made without departing from the spirit and scope of the invention as defined in the following claims.

What is claimed is:

1. A method for automatically measuring propagation characteristics of millimeter radio waves and acquiring data using a simple network management protocol (SNMP) in real time,
wherein a remote server controls a transmitter control terminal and a receiver control terminal, which control a transmitter and receiver separated from each other at a predetermined distance so as to measure propagation characteristics, through a wired/wireless network using the SNMP.

2. The method of claim 1, wherein the remote server directly controls the transmitter and the receiver through the wired/wireless network using the SNMP.

3. The method of claim 1, wherein the remote server provides a user interface configured to check and control an attenuation measurement result, and a data traffic state, the operation states of the transmitter, the receiver, the transmitter control terminal, and the receiver control terminal, which measures the propagation characteristics, in real time.
